(19) United States
(12) Patent Application Publication
(10) Pub. No.: US 2005/0053178 A1
(43) Pub. Date: Mar. 10, 2005

(54) Method and apparatus of speech coding and channel coding to improve voice quality and range in two-way radios

(76) Inventors: Satyanarayan R. Panpaliya, Palatine, IL (US); Joseph E. Phillips, Huntiey, IL (US)

Correspondence Address: MILLER JOHNSON SNELL CUMMISKEY, PLC, 800 CALDER PLAZA BUILDING, 250 MONROE AVE N W, GRAND RAPIDS, MI, 49503-2250, US

(21) Appl. No.: 10/657,985

(22) Filed: Sep. 9, 2003

(51) Int. Cl. H04B 14/04

(52) U.S. Cl. 375/353

(57) ABSTRACT

A two way radio (300) includes a scalable speech coder (306) and a scalable channel coder (308) controlled via a supporting protocol that transmits predetermined digital audio quality and predetermined audio output bit rate information at regular intervals.

### TECHNICAL FIELD

This invention relates in general to radio communications and more particularly to speech and channel coding techniques associated with a digital two-way radio.

### BACKGROUND

In current two-way digital radio communications, a speech call can suddenly be terminated or “dropped” when a user's transmitted signal travels beyond a certain range. In a single site environment these drops are particularly bothersome for users accustomed to analog radio performance. Analog radio users are accustomed to listening to the audio signal until significant degradation in the audio quality occurs. This type of performance does not typically occur in digital communications since the communication is dropped. FIG. 1 is a graph 100 comparing illustrating audio performance for analog radio 102 relative to low bit rate 104 and high bit rate 106 source coded digital audio in accordance with the prior art. As seen in the diagram, the audio output quality 110 remains consistent throughout its range 112 for existing low bit rate 104 and high bit rate 106 digital audio until the radio reaches its current range limit, then the call is dropped as indicated by designators 108, 110.

While the audio output quality of today's digital two-way radios remains fairly consistent throughout a call, audible clicks are typically heard if the radio user is about to cross a certain signal threshold range. Analog radio quality, on the other hand, gradually improves as a user approaches the transmitting device. Conversely, it gradually degrades as the user moves a further distance away from the transmitting station. Current coding schemes and scaling techniques tend to be better suited to improving audio quality in a cellular protocol environment than those related to two-way radio protocol.

Thus, range extension and audio quality are particularly important when dealing with half-duplex two-way communication. Accordingly, there is a need for an improved range extension scheme for two-radio radio communications devices operating using a digital half-duplex two-way radio protocol wherein the received audio quality is altered based upon the signal level of the transmitting station.

### BRIEF DESCRIPTION OF THE DRAWINGS

The features of the present invention, which are believed to be novel, are set forth with particularity in the appended claims. The invention, together with further objects and advantages thereof, may best be understood by reference to the following description, taken in conjunction with the accompanying drawings, in the several figures of which like reference numerals identify like elements, and in which:

FIG. 1 is a graph comparing typical audio performance for analog radio to low bit rate and high bit rate source coded digital audio in accordance with the prior art;

FIG. 2 is a graph comparing the existing audio performance of FIG. 1 to a desired audio performance in accordance with the present invention;

FIG. 3 illustrates a partial block diagram for a digital transceiver for a two-way radio in accordance with the present invention;

FIG. 4 is flow chart diagram illustrating a summary of the steps involved for coding audio in a digital two-way radio in accordance with the present invention;

FIG. 5 is a graph of audio quality versus range comparing a finite step approach to a linear approach in accordance with the present invention;

FIG. 6 is a graph comparing speech coding output rate and channel coding output rate as generated from received bit error rate (BER) information in accordance with the present invention; and

FIG. 7 is chart illustrating a series of computational steps used for determining bit error rate (BER) in a receiver in accordance with the present invention.

### DETAILED DESCRIPTION OF THE PREFERRED EMBODIMENT

While the specification concludes with claims defining the features of the invention that are regarded as novel, it is believed that the invention will be better understood from a consideration of the following description in conjunction with the drawing figures, in which like reference numerals are carried forward.

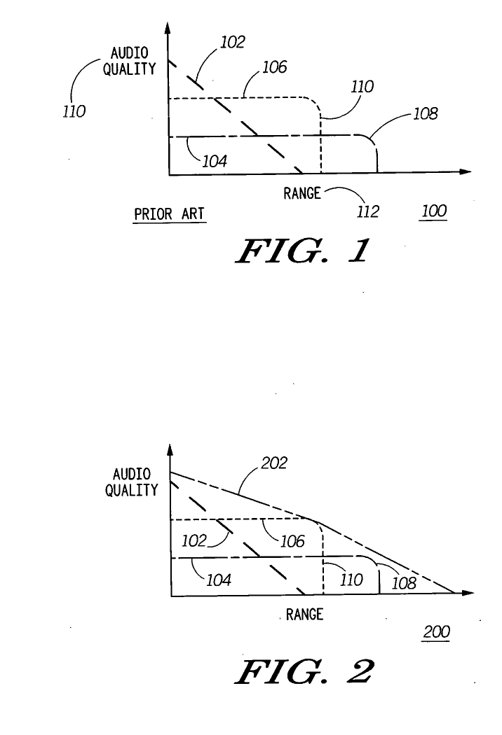

In accordance with the present invention, there is described herein a means and method for extending audio quality and range in a digital two-way radio communication device. As seen in FIG. 2, the graph 200 depicts a comparison of the existing audio as seen in prior art FIG. 1 with a desired audio performance 202. As will be recognized by those skilled in the art, the invention utilizes an improved range and speech quality that is obtained by providing a scalable channel coder and scalable speech coder. The scalable speech coder will also be referred to herein as a scalable vocoder. The scalable speech coder's output bit rates are adjusted according to channel error conditions and receiver sensitivity. Thus, instead of dropping a call, the speech coder and channel coder of the present invention are used to extend the range of the audio link.

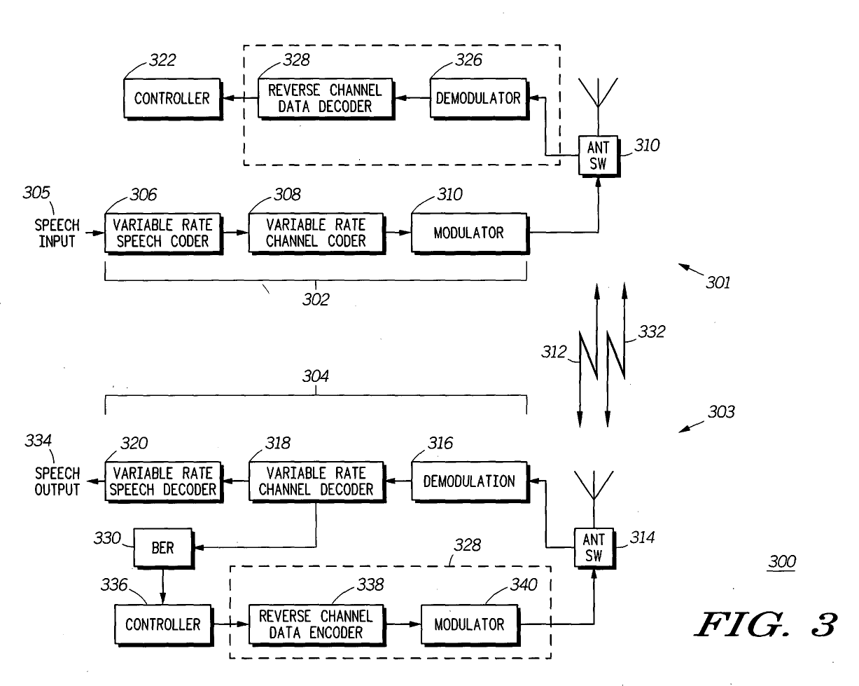

FIG. 3 illustrates a partial block diagram of a communications system 300 including two half-duplex communication devices, preferably first and second two-way radios 301, 303, formed and operating in accordance with the present invention. For the purposes of this description, first radio 301 will be considered the primary transmitting radio 301 and second radio 303 will be considered the primary receiving radio 303. The transmitting radio 301 includes a transmit path 302 that processes an incoming speech signal 305 through a variable rate speech coder 306, a variable rate channel coder 308, and a modulator 310 to generate a radio frequency (RF) output signal 312. Additionally, the transmitting radio 301 also includes a controller 322, and a receiver 324, the receiver including a demodulator 326 and a reverse channel data decoder 328. An antenna switch 310 is typically used to switch between transmit and receive modes.

Additionally, the receiving radio 303 includes a receive path 304 that processes an incoming RF signal 332 through a demodulator 316, a variable rate channel decoder 318 and a variable rate speech decoder 320 to generate speech output 334. The receiving radio 303 further includes a controller 336 and a transmitter 328. The transmitter 328 includes a reverse channel data decoder 338 and a modulator 340. An antenna switch 314 is also used to switch between receive and transmit modes.

In accordance with the preferred embodiment of the invention, the receiving radio 303 conveys and/or transmits BER data to the main transmitting radio 301 along with desired predetermined audio quality and range parameters. The transmitting radio 301 processes the BER information and transmits adjusted or modified parameters to the receiving radio 303. These adjusted parameters are sent in order to adjust and control the functionality of the variable rate channel decoder 318 and the variable rate speech decoder 320 of the receiving radio 303. At the same time receiver 303 has capability to identify what has changed or has remained unchanged within the received frame.

In accordance with the present invention, the variable bit rate aspect of the channel decoder 318, channel encoder 308, speech decoder 320, and speech coder 306 provides scalability and dynamic control to these devices. Thus, in accordance with the present invention, receiving radio 303 can be viewed as comprising a scalable digital vocoder 320 and a scalable channel decoder 318. Likewise, in accordance with the present invention, digital radio 301 can be viewed as comprising a dynamic digital vocoder 306 and a dynamic channel coder 308. The supporting protocol provided via controller 322 provides predetermined digital audio quality and predetermined audio output bit rate information at regular intervals to control the scalable digital vocoder 306 and the scalable channel coder 308. The scalability aspect of both of these coders allows the digital audio quality to be controlled such that it can be easily varied linearly with bit error rate (BER). Since the BER generally corresponds to the distance the receiving station is from the transmitting station, this achieves the desired behavior as seen in FIG. 2.

To achieve the desired linear performance, predetermined digital audio quality and predetermined audio output bit rate information are transmitted to the coders 306, 308 via extra bits allocated in a reverse channel decoder 328. For the first embodiment of the invention, the digital two-way protocol originating from controller 336 utilizes a reverse channel to transmit relevant system parameters from the receiving radio 303 to the main transmitting radio 301 at regular intervals. In this case, the reverse channel control protocol includes a sufficient number of bits to transmit the bit rate related information regularly.

As seen in FIG. 3, the steps involved for coding audio in a digital two-way radio in accordance with the present invention include: receiving an audio speech input signal 305; converting the audio speech input signal 305 to an RF signal using speech coder 306; channel coder 308 and modulator 310; transmitting the RF signal 312; receiving the RF signal 312; converting the RF signal to an audio signal using speech decoder 320; channel decoder 318 and demodulator 316; determining the BER of the audio signal from the variable rate channel decoder 318; determining a relation for the variable bit rate coder 308 and variable speech coder 306 from the BER; and modulating the output bits at modulator 340 on the reverse channel encoder 338 and transmitting an updated output signal 332 from receiving radio 303 to the transmitting radio 301. As will be further recognized by those skilled in the art, fewer bits are typically available to the reverse channel protocol, thus a finite step approach to coding may be preferable to the continuous linear approach.

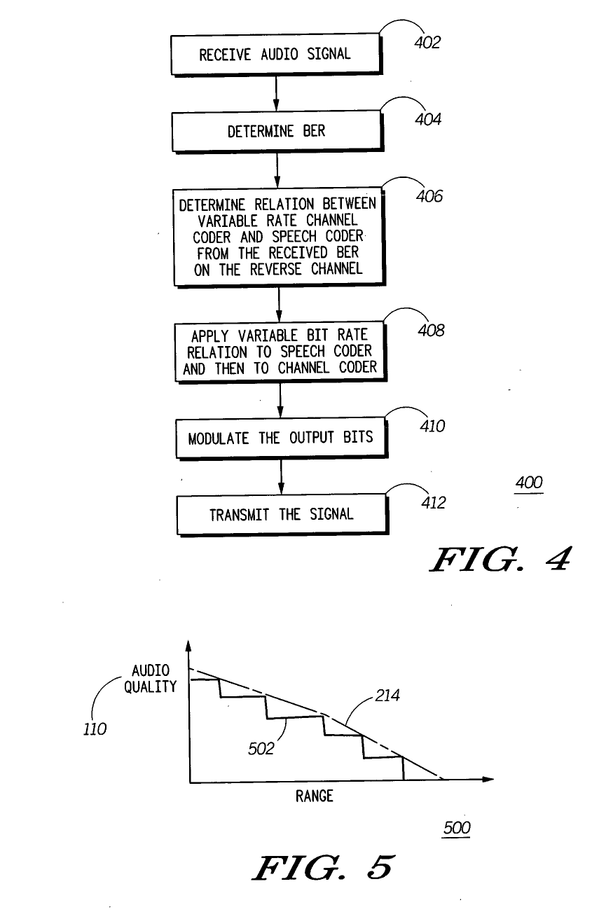

Thus, FIG. 4 summarizes the audio coding process discussed above using a flow chart diagram in accordance with the present invention. These steps include receiving an audio signal 402, determining the BER 404, determining the relationship between the variable rate channel coder and speech coder from the received BER on the reverse channel 406, applying the variable bit rate relation to the speech coder and channel coder 408, modulating the output bits 410 and then transmitting the output signal.

Referring now to FIG. 5, there is shown a graph 500 of audio quality versus range comparing a finite step approach 502 in accordance with a second embodiment of the invention. FIG. 5 depicts a process contrary to the linear approach 214 as shown previously in FIG. 2. In accordance with the second embodiment of the invention, the variable speech coder 306 and the variable channel coder 308 of FIG. 3 take a finite number of steps to generate their respective output bits. Information pertaining to these finite bits is transmitted via the control protocol at regular intervals. Thus, the output format of the variable speech coder 306 and the variable channel coder 308 is known prior to the receiver architecture. As further recognized by those skilled in the art, the steps of method 400 in FIG. 4 apply to this second embodiment of the invention as well. In accordance with the second embodiment, the determination step 406 is implemented by applying the variable speech bit rate and the variable channel bit rate to the audio signal at regular intervals so as to approximate a predetermined continuous relationship. In this case, this is a stepped linear relationship, between audio quality and range.

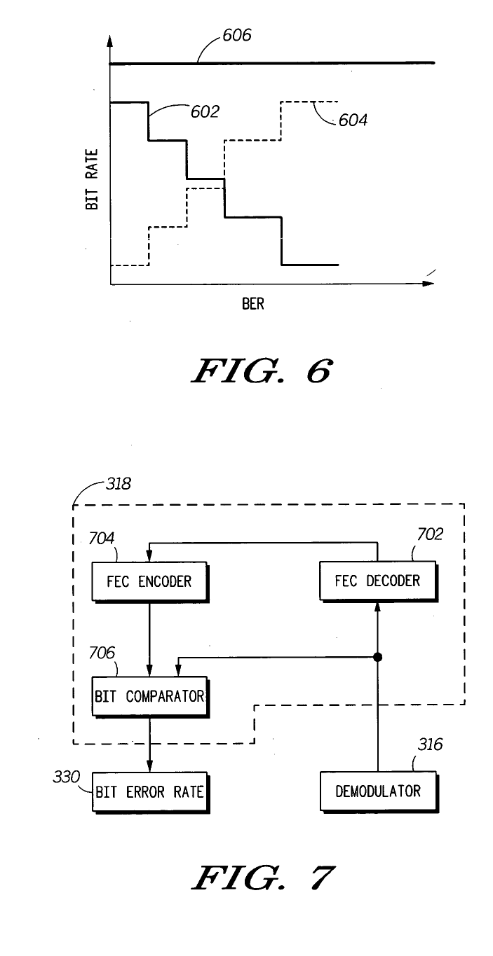

In accordance with yet a third embodiment of the invention, the BER is used to determine the output source coding bit rate (CBR). The output bit rate of the variable rate speech coder and variable rate channel coder are controlled on the basis of message error rate (MER) generated from the BER of the received signal. Quality requirement information is transmitted back to the transmitting device so that the transmitting device can generate scalable speech coder frames and channel coder frames. FIG. 6 illustrates an example of a graph 600 comparing speech coding output rate 602 and forward error correction (FEC) output rate 604. As known by those skilled in the art, FEC is a form of channel coding and is generated from received BER information. The received BER is calculated by counting the number of differences between received bits at the receiver input and the output of the variable rate channel decoder 318. A representation of BER determination is shown in FIG. 7 that includes utilizing the output 702 of the demodulator 316 through the variable rate channel decoder 318 implemented in the figure as an FEC decoder 702, FEC encoder 704 and comparator 706. The comparator output is the bit error rate 330.

Since the modulation scheme and allocated bandwidth are limited and fixed, the total gross bit rate 606 as seen in FIG. 6 remains constant at all times. Thus, any adjustment to total output encoded bits 606 is done between channel coding bits 604 and speech coding output bits 602 according to received BER 330. As noted with reference to FIG. 2, the output bit error related information is used within the protocol of controller 322 to add extra bits in forward channel signaling. The controller 322 then transmits the bit rate related information in terms of “steps” to radio 303 at regular intervals with the receiver 304 adjusting its decoding bit rate accordingly.

Thus, the third embodiment of the invention achieves the outcome described in the second embodiment without the use of additional bits. In this solution, the existing method of BER transmission and reception is modified. Typically, the main transmitter uses the BER related information to control the output RF-power. In accordance with the third embodiment, the main transmitter is modified so that BER related information can be used for either power control or for controlling the output source coding bit rate. Thus, in accordance with the third embodiment, the main transmitter receives signaling frames containing a bit error rate (BER) in reverse channel and utilizes the BER for selectively controlling a radio frequency (RF) power output and source coding bit rate. The bit error rate value is mapped to generate speech coder and channel coder steps. The transmitter then adjusts the channel coding and speech coding rate according to the received bit rate. The receiver then predicts the channel coding and speech coding format from the BER it has sent in the previous reverse signaling frame.

In still yet a fourth embodiment, instead of sending BER, received audio quality measurements are sent on the reverse channel. The audio quality can be computed at the receiving radio 303 by determining the audio frames that need repeating at the decoder 318 or it can be computed from the major errors in the decoder data frame. Thus, in accordance with the fourth embodiment, the main transmitter 301 receives signaling frames containing audio quality information in a reverse channel and utilizes the audio quality measurements for source coding bit rate. The audio quality measurements are mapped to generate speech coder 306 and channel coder 308 steps. The transmitter path 302 of radio 301 then adjusts the channel coding and speech-coding rate according to the received bit rate. The receiver path 304 of radio 303 then predicts the channel coding and speech-coding format from the audio quality measurements it has sent in the previous reverse signaling frame.

The variable speech coder output bit rate is preferably scaled within a predetermined range, such as for example from 1 to 9 kilobits per second (KBPS) depending on system parameters such as available transmission bit rate. The dynamic channel coder or adaptive channel coder of the present invention adjusts the output bit rate according to the BER or MER or audio quality measurements. Those skilled in the art will recognize that different system requirements may require different scaling factors; however, the ability to dynamically scale the coding enables significant control over range and audio quality.

Accordingly, the present invention describes a variable bit rate vocoder and variable bit rate channel coder which is a novel improvement over the fixed bit rate vocoder and channel coder used presently within digital simplex communications devices. A digital radio formed in accordance with the present invetion can receive signaling frames containing a bit error rate (BER), or audio quality measurements with the receiver utilizing the BER or audio quality meassurements or selectively controlling a radio frequency (RF) power output and source coding bit rate for the digital radio. Moreover, by modifying the BER related algorithms to provide for variable bit rates, a new means of controlling FEC and speech coder rate formatting has been provided for improved audio quality and range. The coding schemes of the present invention provide a dynamic scaling approach for two-way digital radio designs. Existing digital protocols do not dynamically scale the vocoder output rate or the channel coder output rate. By utilizing dynamic scaling approach such as linear or stepped the audio quality and range of digital two-way radio is greatly improved.

While the preferred embodiments of the invention have been illustrated and described, it will be clear that the invention is not so limited. Numerous modifications, changes, variations, substitutions and equivalents will occur to those skilled in the art without departing from the spirit and scope of the present invention as defined by the appended claims.

1. The digital half-duplex communication device, including:
a scalable digital vocoder;
a scalable channel coder;
the scalable digital vocoder and the scalable channel coder being controlled by a supporting protocol that transmits predetermined digital audio quality and predetermined audio output bit rate information at regular intervals to the digital half-duplex communication device; and
wherein the predetermined digital audio quality and predetermined audio output bit rate information are transmitted by allocating extra bits in a reverse channel.

2. (Canceled)

3. The digital half-duplex communication device of claim 1, wherein the communication device comprises a digital two-way radio.

4. A communication system, comprising:
a transmitting device providing a supporting protocol that transmits bit error rate (BER) information at regular intervals to a receiving device;
the receiving device, including:
a speech coder;
a channel coder; and
the channel coder and speech coder output bit rates are derived from the BER information; wherein
the BER information is transmitted by allocating extra bits in a reverse channel.

5. A digital two-way radio, including:
a digital vocoder having a scalable output bit rate; and
an adaptive channel coder to adjust the output bit rate according to one of bit error rate and channel error conditions.

6. A method for coding audio in a two-way radio having a channel coder and a speech coder, including:
receiving an audio signal;
generating a variable speech bit rate and a variable channel bit rate; and
applying the variable speech bit rate and the variable channel bit rate to the channel coder and speech coder at regular intervals so as to approximate a predetermined relationship between audio quality and range.

7. The method of claim 6, wherein the step of applying further comprises:
applying the variable speech bit rate and the variable channel bit rate to the channel coder and speech coder at regular intervals so as to approximate a continuous linear relationship between audio quality and range.

8. The method of claim 6, wherein the step of applying further comprises:
applying the variable speech bit rate and the variable channel bit rate to the channel coder and speech coder at regular intervals so as to approximate a continuous stepped relationship between audio quality and range.

9. A method for coding audio in a two-way radio having a channel coder and a speech coder, comprising the steps of:
receiving an audio signal;
determining the bit error rate (BER) of the audio signal;
generating a variable speech bit rate and a variable channel bit rate from the BER;
scaling the speech coder with the variable speech bit rate;
scaling the channel coder with the variable channel bit rate; and
controlling the variable speech bit rate and the variable channel bit rate on the basis of bit error rate (BER) of the received audio signal that is received in a reverse channel.

10. A method for coding in a two-way digital radio, comprising the steps of:
receiving an audio signal at a vocoder;
scaling the vocoder output;
scaling a channel coder output based on the vocoder output;
controlling the output bit rate of the speech coder and channel coder on the basis of message error rate/bit error rate (MER/BER) information of the received signal;
transmitting quality requirement information to a transmitting device in a reverse channel; and
generating scalable speech coder and channel coder frames.

11. A digital half-duplex radio, comprising a receiver receiving signaling frames containing a bit error rate (BER), the receiver utilizing the BER for selectively controlling a radio frequency (RF) power output and source coding bit rate for the digital radio.

12. A digital radio, comprising:
a receiver receiving signaling frames containing a bit error rate (BER), the receiver utilizing the BER for selectively controlling a radio frequency (RF) power output and source coding bit rate for the digital radio; and
when the source coding bit rate is selected:
the BER being mapped to generate speech coder and channel coder steps;
the radio further comprising:
a transmitter adjusting for forward error correction (FEC) and speech coding rate in response to the speech coder and channel coder steps; and
the receiver predicting the FEC and speech coding format from the BER sent in a reverse signaling frame.

13. A digital two-way radio, including:
a digital speech coder scaled to provide an audio quality that varies linearly with audio quality measurements computed at a receiver, the audio quality being mapped according to variable length channel coding and variable length source coding rate received in a reverse channel;
an adaptive channel coder having an adjustable output bit rate; and
a supporting protocol that transmits bit rate information at regular intervals to a supporting communication device.
